(19) United States
(12) Patent Application Publication
(10) Pub. No.: US 2014/0354907 A1
(43) Pub. Date: Dec. 4, 2014

(54) COMPOSITE TOUCH COVER PLATE

(71) Applicants: Yu-Hua Wu, Taoyuan County (TW); Siang-Lin Huang, Taichung City (TW); Cheng-Chieh Hung, Taichung City (TW); Hen-Ta Kang, Taichung City (TW); Wen-Chun Wang, Taichung City (TW)

(72) Inventors: Yu-Hua Wu, Taoyuan County (TW); Siang-Lin Huang, Taichung City (TW); Cheng-Chieh Hung, Taichung City (TW); Hen-Ta Kang, Taichung City (TW); Wen-Chun Wang, Taichung City (TW)

(73) Assignee: WINTEK CORPORATION, Taichung City (TW)

(21) Appl. No.: 14/294,099

(22) Filed: Jun. 2, 2014

(30) Foreign Application Priority Data
Jun. 3, 2013 (TW) 102119641

(51) Int. Cl. G06F 3/041

(52) U.S. Cl. CPC G06F 3/041
USPC 349/12

(57) ABSTRACT

A composite touch cover plate defined with a touch surface and an inner surface is provided. The composite touch cover plate includes a substantially homogeneous polymer layer and a fibrous layer. The fibrous layer is located at one side of the polymer layer and near the touch surface. A ratio of a thickness of the fibrous layer to a thickness of the polymer layer lies between 1:9 and 1:49.

### CROSS-REFERENCE TO RELATED APPLICATION

This application claims the priority benefit of Taiwan application serial no. 102119641, filed on Jun. 3, 2013. The entirety of the above-mentioned patent application is hereby incorporated by reference herein and made a part of this specification.

### BACKGROUND OF THE INVENTION

1. Field of Invention

The invention relates to a composite touch cover plate and particularly to a composite touch cover plate with a good tolerance.

2. Description of Related Art

A conventional display panel, such as a touch panel, a display panel and a touch display panel, etc., uses tempered glass extensively as a substrate or a cover plate. However, as the demand for large-size panels of smart phones, tablet computers and even of notebook computers and smart TVs increases, the inconvenience of the tempered glass becomes increasingly evident. Although the tempered glass has a beautiful texture, its shortcomings of being relatively thick and prone to be broken narrow the application scope of the panels which are applied with the tempered glass.

Compared to the panel composed of the tempered glass, a flexible substrate (such as a plastic substrate) has characteristics such as flexibility and impact resistance. Therefore, in recent years, the flexible substrate has been widely applied to the display and the touch fields. However, since the current flexible substrates can not resist the high temperature (low melting point), the tolerance of the panel to the processing temperatures is then reduced. Moreover, the current flexible substrates are often unable to pass the drop ball test, which means that the current flexible panels may be ruptured easily and hence damaged if subjecting to the impact of external forces during use. Thus, the impact resistance of the current flexible panels still need to be improved.

### SUMMARY OF THE INVENTION

The invention provides a composite touch cover plate, which has good tolerance under impact of external forces.

The composite touch cover plate of the invention, which is defined with a touch surface and an inner surface opposite to the touch surface, wherein the composite touch cover plate comprises a substantially homogeneous polymer layer and a fibrous layer. The fibrous layer is located at one side of the polymer layer and near the touch surface. A ratio of a thickness of the fibrous layer to a thickness of the polymer layer lies between 1:9 and 1:49.

In an embodiment of the invention, the ratio of the thickness of the fibrous layer to the thickness of the polymer layer lies between 1:9 and 1:19.

In an embodiment of the invention, materials of the above polymer layer comprise polycarbonate (PC), polyethylene terephthalate (PET), triacetyl cellulose (TAC), polymethyl methacrylate (PMMA), or polyimide (PI).

In an embodiment of the invention, materials of the fibrous layer comprise glass fiber, carbon fiber, plastic fiber, or a mixture of at least two of the above materials.

In an embodiment of the invention, the materials of the fibrous layer further comprise a polymer base, and the glass fiber, the carbon fiber, the plastic fiber, or the mixture of at least two of the above materials are distributed in the polymer base.

In an embodiment of the invention, materials of the polymer base are the same as the materials of the polymer layer.

In an embodiment of the invention, the fibrous layer adheres to the polymer layer through a bonding layer.

In an embodiment of the invention, the materials of the fibrous layer further comprise a vitreous spacer, a plastic spacer, or a mixture of the above two materials to support between the glass fiber, the carbon fiber, the plastic fiber, or a mixture of at least two of the above materials.

In an embodiment of the invention, an overall thickness of the composite touch cover plate lies between 0.3 mm and 2 mm.

In an embodiment of the invention, an overall haze of the composite touch cover plate lies between 2% and 2.5%.

In an embodiment of the invention, the fibrous layer comprises a plurality of sub-layers.

In an embodiment of the invention, at least one of the sub-layer adheres to the polymer layer through a bonding layer, and a ratio of a total thickness of the fibrous layer and the bonding layer to the thickness of the polymer layer lies between 1:9 and 1:49.

In an embodiment of the invention, the composite touch cover plate further comprises a first hardened layer, which is disposed above the fibrous layer, and a second hardened layer, which is disposed below the polymer layer. The fibrous layer and the polymer layer are located between the first and the second hardened layer.

In an embodiment of the invention, a pencil hardness of the first hardened layer lies between 4H and 9H.

In an embodiment of the invention, a pencil hardness of the second hardened layer is less then 1H.

In an embodiment of the invention, thicknesses of the first hardened layer and the second hardened layer are respectively less then 10 μm.

In an embodiment of the invention, the composite touch cover plate further comprises a touch sensor layer, wherein the polymer layer is located between the touch sensor layer and the fibrous layer.

Based on the above, the composite touch cover plate of the invention is composed of the fibrous layer having relatively high impact resistance capability and the polymer layer having relatively high impact absorbing capability. Therefore, as the composite touch cover plate is performed with a drop ball test or is under the impact of an external force, the fibrous layer which is located at the touch surface (usually the impacted side of the composite touch cover plate) can resist the impact of external forces, thereby preventing the impacted touch surface from directly rupturing. Also, as stresses pass down, the polymer layer which is located below the fibrous layer can absorb the stresses, thereby preventing the composite touch cover plate from inside or bottom cracking. Accordingly, the composite touch cover plate can have good tolerance under the impact of external forces.

In order to make the aforementioned and other features and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-section schematic diagram of a composite touch cover plate according to the first embodiment of the invention.

FIG. 2 is a cross-section schematic diagram of a composite touch cover plate according to the second embodiment of the invention.

FIG. 3 is a cross-section schematic diagram of a composite touch cover plate according to the third embodiment of the invention.

FIG. 4 is a cross-section schematic diagram of a composite touch cover plate according to the fourth embodiment of the invention.

FIG. 5 is a cross-section schematic diagram of a composite touch cover plate according to the fifth embodiment of the invention.

FIG. 6 is a cross-section schematic diagram of a composite touch cover plate according to the sixth embodiment of the invention.

### DESCRIPTION OF EMBODIMENTS

Reference will now be made in detail to the present embodiments of the invention, examples of which are illustrated in the accompanying drawings. Wherever possible, the same reference numbers are used in the drawings and the description to refer to the same or like parts.

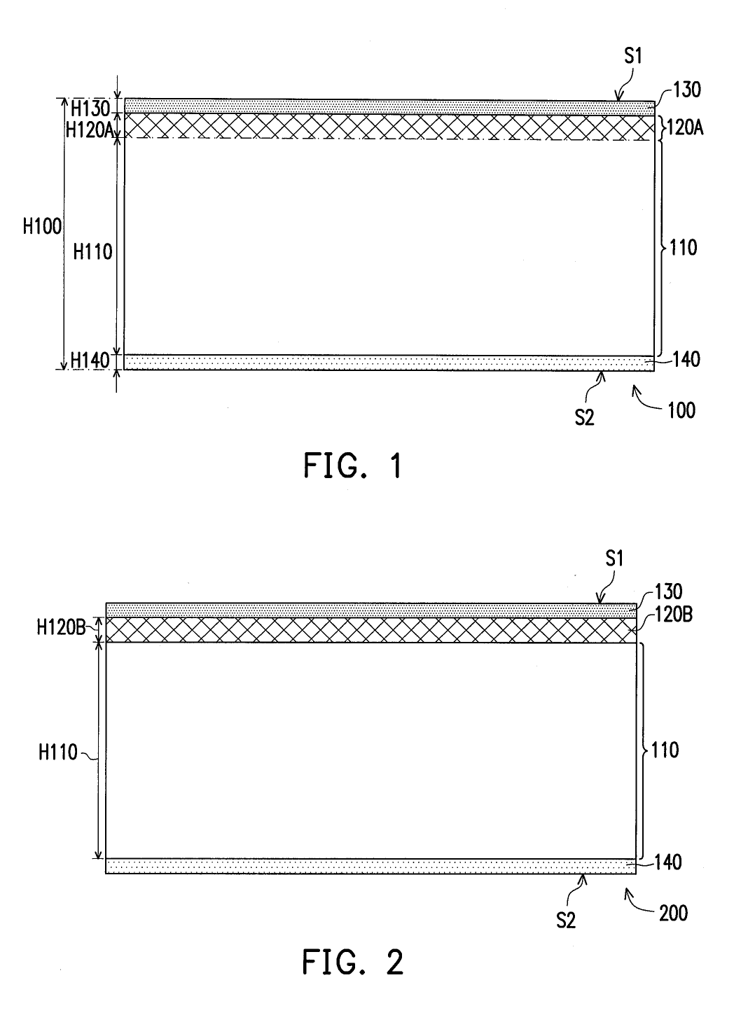

FIG. 1 is a cross-section schematic diagram of a composite touch cover plate according to the first embodiment of the invention. Please refer to FIG. 1, the composite touch cover plate 100 of the present embodiment is defined with a touch surface S1 and an inner surface S2 opposite to the touch surface S1. Specifically, the composite touch cover plate 100 comprises a polymer layer 110 and a fibrous layer 120A, wherein the fibrous layer 120A is located at one side of the polymer layer 110 and near the touch surface S1.

In the present embodiment, the polymer layer 110 may be, for example, a flexible and substantially homogeneous structure with good light transmittance. Specifically, materials of the polymer layer may be polymer materials such as polycarbonate, polyethylene terephthalate, triacetyl cellulose, polymethyl methacrylate, or polyimide, etc. On the other hand, materials of the fibrous layer 120A may be the materials having interlaced structures such as glass fiber, carbon fiber, plastic fiber or a mixture of at least two of the above materials. Furthermore, the materials of the fibrous layer 120A may selectively comprise a vitreous spacer or a plastic spacer, or a mixture of the above two materials to support between the glass fiber, the carbon fiber, the plastic fiber, or a mixture of at least two of the above materials.

In the present embodiment, the materials of the fibrous layer 120A may further comprise a polymer base. Moreover, the glass fiber, the carbon fiber, the plastic fiber, or the mixture of at least two of the above materials, and the vitreous spacer, the plastic spacer, or the mixture of the two materials are distributed in the polymer base. The materials of the polymer base may be selected from the materials of the polymer layer. For example, the materials of the polymer base may be such as polycarbonate, polyethylene terephthalate, triacetyl cellulose, polymethyl methacrylate, or polyimide.

Furthermore, a method of forming the composite touch cover plate 100 may be exemplified as follows. The polymer base containing the above fiber or the spacer is formed on the polymer layer 110 by dripping, followed by molding through a thermal curing process. For example, the materials of the polymer base of the present embodiment are used the same materials as the polymer layer 110, and the fibrous layer 120A molds together with the polymer layer 110 through the thermal curing process. Accordingly, there is no obvious interface existing at a boundary between the polymer layer 110 and the fibrous layer 120A of the present embodiment (shown by dotted lines in FIG. 1). In other embodiments, when the materials of the polymer base are used which are different from the materials of the polymer layer 110, or when the fibrous layer 120A is curing after the curing of the polymer layer 110, then there may be an obvious interface existing at the boundary between the polymer layer 110 and the fibrous layer 120A. In other embodiments, the method of forming the composite touch cover plate 100 may also be changed to put the fiber or spacer on the polymer layer 110 first, then to cover the fiber or spacer with the polymer base by dripping or other similar ways, and finally, to perform thermoforming. As to the materials of the polymer base, they may be the same materials as or different materials from the polymer layer 110.

In the present embodiment, the tolerance of the composite touch cover plate 100 under the impact of external forces can be enhanced through the disposition of the polymer layer 110 and the fibrous layer 120A. Specifically, the materials of the fibrous layer 120A of the present embodiment have a relatively high stiffness, thereby having a relatively high impact resistance capability. On the other hand, the materials of the polymer layer 110 are relatively soft, thereby having a relatively high impact absorbing capability. Accordingly, through disposing the fibrous layer 120A at the side of the touch surface S1 of the composite touch cover plate 100, which is usually the impacted side of the composite touch cover plate 100, when the composite touch cover plate 100 is performed with a drop ball test or is under the impact of external forces, the fibrous layer 120A near the touch surface S1 can resist the impact of external forces, thereby preventing the impacted touch surface S1 (that is, the side of the fibrous layer 120A) from directly rupturing. On the other hand, as stresses pass down, the polymer layer 110 which is located below the fibrous layer 120A can absorb the stresses, thereby preventing the composite touch cover plate 100 from inside or bottom (that is, the side of the polymer layer 110) cracking. Accordingly, through the disposition of the polymer layer 110 and the fibrous layer 120A, the composite touch cover plate 100 has good tolerance under the impact of external forces.

Furthermore, considering both the flexibility and the tolerance of the composite touch cover plate 100, a ratio of a thickness H120A of the fibrous layer 120A to a thickness H110 of the polymer layer 110 of the composite touch cover plate 100 of the present embodiment lies between 1:9 and 1:49, and preferably lies between 1:9 and 1:19.

The fibrous layer 120A of the present embodiment not only can enhance the tolerance to the impact of external forces, but also can enhance the tolerance of the composite touch cover plate 100 to high temperatures. Specifically, a general flexible substrate can withstand temperatures up to about 110° C. In contrast, in the present embodiment, through the disposition of the fibrous layer 120A, the composite touch cover plate 100 is allowed to withstand temperatures up to about 240° C. Therefore, a panel which is applied with the touch cover plate 100 of the present embodiment, such as a display panel, a touch panel or a touch display panel, can tolerate relatively high processing temperatures.

Furthermore, through the fibrous layer 120A, an overall haze of the touch cover plate 100 of the present embodiment can be made to lie between 2% and 2.5%, thereby making the display which is applied with the touch cover plate 100 of the present embodiment be capable of eliminating the mura phenomenon and further improve the display qualities.

In the present embodiment, the composite touch cover plate 100 may further comprise the first hardened layer 130, which is disposed above a fibrous layer 120A, and the second hardened layer 140, which is disposed below the polymer layer 110. Through disposing the polymer layer 110 and the fibrous layer 120A between the first hardened layer 130 and the second hardened layer 140, the fibrous layer 120A and the polymer layer 110 not only can be protected (for example, to prevent from scratching), but also can be prevented from curling because of being heated (due to different coefficients of thermal expansion), thereby maintaining the flatness of the composite touch cover plate 100.

Furthermore, the thickness H130 of the first hardened layer 130 and the thickness H140 of the second hardened layer 140 of the present embodiment are less then 10 μm, respectively. The overall thickness H100 of the composite touch cover plate 100 of the present embodiment (that is, the sum of the thickness H110 of the polymer layer 110, the thickness H120A of the fibrous layer 120A, the thickness H130 of the first hardened layer 130 and the thickness H140 of the second hardened layer 140) lies between, for example, 0.3 mm and 2 mm.

Since the thickness H130 and H140 of the first hardened layer 130 and the second hardened layer 140 are relatively thin, the hardness of the first hard layer 130 and the second hard layer 140 may be relevant to the hardness of the material in contact therewith. In the present embodiment, for example, the pencil hardness of the second hardened layer 140 is less then 1H, and the pencil hardness of the first hardened layer 130 lies between 4H and 9H.

FIG. 2 is a cross-section schematic diagram of a composite touch cover plate according to the second embodiment of the invention. Please refer to FIG. 2, the touch cover plate 200 of the present embodiment has the similar structure and function to those of the touch cover plate 100 in FIG. 1. The difference between the touch cover plate 100 and the touch cover plate 200 is that the fiber layer 120B of the present embodiment is made by co-extrusion.

Specifically, the method of forming the composite touch cover plate 200 comprises, for example, the following steps. First, a molten state of a polymer base is formed in a mold (not shown). Materials of the polymer base can be selected from the materials of the polymer layer 110, but the invention is not intended to limit that the materials of the polymer base and the materials of the polymer layer 110 need to be the same. Then, the glass fiber, the carbon fiber, the plastic fiber or the mixture of at least two of the above materials are put into the mold and distributed in the polymer base. Finally, the materials of the polymer layer 110 are injected into the mold, and the touch cover plate 200 of the present embodiment is made by co-extrusion.

It should be noted that, after putting the glass fiber, the carbon fiber, the plastic fiber or the mixture of at least two of the above materials into the mold, the glass fiber, the carbon fiber, the plastic fiber or the mixture of at least two of the above materials will sink to the bottom of the mold due to gravity. Therefore, after being co-extruded, the fibrous layer 120B will be located at one side of the polymer layer 110 and near the touch surface S1. In the present embodiment, for example, the materials of the polymer base are used which are different form the materials of the polymer layer 110. Accordingly, it is likely to have an obvious interface existing at a boundary between the polymer layer 110 and the fibrous layer 120B. In other embodiments, the materials of the polymer base can also be used the same as the materials of the polymer layer 110. Accordingly, no obvious interface will exist at the boundary between the polymer layer 110 and the fibrous layer 120B.

In the present embodiment, the composite touch cover plate 200 is composed of the fibrous layer 120B having relatively high impact resistance capability and the polymer layer 110 having relatively high impact absorbing capability. Therefore, as the composite touch cover plate 200 is performed with a drop ball test or is under the impact of external forces, the fibrous layer 120B which is located near the touch surface S1 (usually also the impacted side) can resist the impact of external forces, thereby preventing the impacted touch surface S1 from directly rupturing. Also, as stresses pass down, the polymer layer 110 which is located below the fibrous layer 120B can absorb the stresses, thereby preventing the composite touch cover plate 200 from inside or bottom cracking. Accordingly, the composite touch cover plate 200 can have good tolerance under the impact of external forces.

Furthermore, considering both the flexibility and the tolerance of the composite touch cover plate 200, a ratio of a thickness H120B of the fibrous layer 120B to a thickness H110 of the polymer layer 110 of the composite touch cover plate 200 of the present embodiment lies between 1:9 and 1:49, and preferably lies between 1:9 and 1:19.

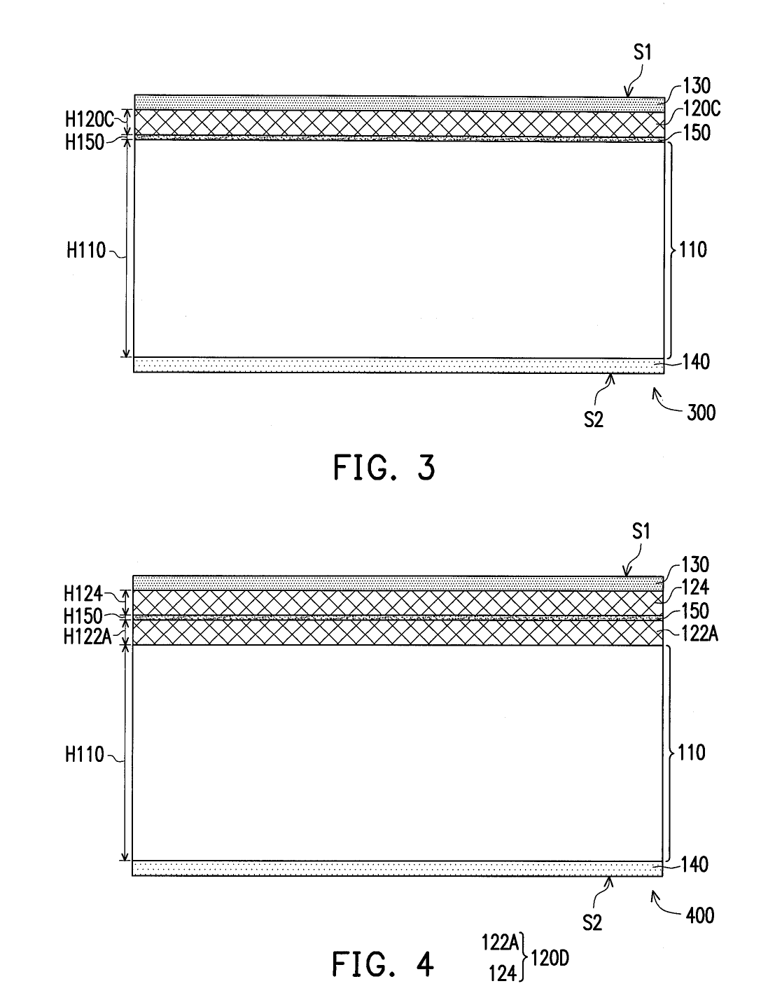

FIG. 3 is a cross-section schematic diagram of a composite touch cover plate according to the third embodiment of the invention. Please refer to FIG. 3, the touch cover plate 300 of the present embodiment has the similar structure and function to those of the touch cover plate 200 in FIG. 2. The difference between the touch cover plate 200 and the touch cover plate 300 is that the fiber layer 120C of the present embodiment adheres to the polymer layer 110 through the bonding layer 150.

In the present embodiment, the composite touch cover plate 300 is composed of the fibrous layer 120C having relatively high impact resistance capability and the polymer layer 110 having relatively high impact absorbing capability. Therefore, as the composite touch cover plate 300 is performed with the drop ball test or is under the impact of external forces, the fibrous layer 120C which is located at the touch surface S1 can resist the impact of external forces, thereby preventing the impacted touch surface S1 from directly rupturing. Also, as stresses pass down, the polymer layer 110 which is located below the fibrous layer 120C can absorb the stresses, thereby preventing the composite touch cover plate 300 from inside or bottom cracking. Accordingly, the composite touch cover plate 300 can have good tolerance under the impact of external forces.

Furthermore, considering both the flexibility and the tolerance of the composite touch cover plate 200, a ratio of a total thickness of the fibrous layer 120C and the bonding layer 150 (that is, the sum of the thickness H120C of the fibrous layer 120C and the thickness H150 of the bonding layer 150) to a thickness H110 of the polymer layer 110 lies between 1:9 and 1:49, and preferably lies between 1:9 and 1:19.

FIG. 4 is a cross-section schematic diagram of a composite touch cover plate according to the fourth embodiment of the invention. Please refer to FIG. 4, the touch cover plate 400 of the present embodiment has the similar structure and function to those of the touch cover plate 100 in FIG. 1. The difference between the touch cover plate 400 and the touch cover plate 100 is that the fiber layer 120D of the present embodiment comprises a plurality of sub-layers. Further, the fiber layer 120D of the present embodiment includes the first sub-layer 122A and the second sub-layer 124, wherein the method of forming the first sub-layer 122A can be used with the method of forming the fibrous layer 120A in FIG. 1 or FIG. 2, and the method of forming the second sub-layer 124 can be used with the method of forming the fibrous layer 120C in FIG. 3. Furthermore, the sub-layer 122A is in direct contact with the polymer layer 110 without the bonding layer 150 in between, whereas the second sub-layer 124 adheres to the first sub-layer 122 through the bonding layer 150.

It should be noted that, although the monolayer second sub-layer 124 disposing on the first sub-layer 122A is exemplified in the invention, the invention is not intended to limit the number of the second sub-layer 124 disposing on the first sub-layer 122A, but to illustrate the ratio of the total thickness of the fibrous layer 120D and the bonding layer 150 (that is, the sum of the thickness H122A of the sub-layer 122A, the thickness H124 of the second sub-layer 124 and the thickness H150 of the bonding layer 150) to the thickness H110 of the polymer layer 110 lies between 1:9 and 1:49, and preferably lies between 1:9 and 1:19. In other embodiments, the number of the second sub-layer 124 disposing on the first sub-layer 122A can also be greater than 1, wherein the plurality of the second sub-layer 124 can be connected to each other, for example, through the plurality of the bonding layer 150 in between. That is, the number of the bonding layer 150 can be the same as the number of the second sub-layer 124.

In the present embodiment, the composite touch cover plate 400 is composed of the fibrous layer 120D having relatively high impact resistance capability and the polymer layer 110 having relatively high impact absorbing capability. Therefore, as the composite touch cover plate 400 is performed with a drop ball test or is under the impact of external forces, the fibrous layer 120D which is located at the touch surface S1 can resist the impact of external forces, thereby preventing the impacted touch surface S1 from directly rupturing. Also, as stresses pass down, the polymer layer 110 which is located below the fibrous layer 120D can absorb the stresses, thereby preventing the composite touch cover plate 400 from inside or bottom cracking. Accordingly, the composite touch cover plate 400 can have good tolerance under the impact of external forces.

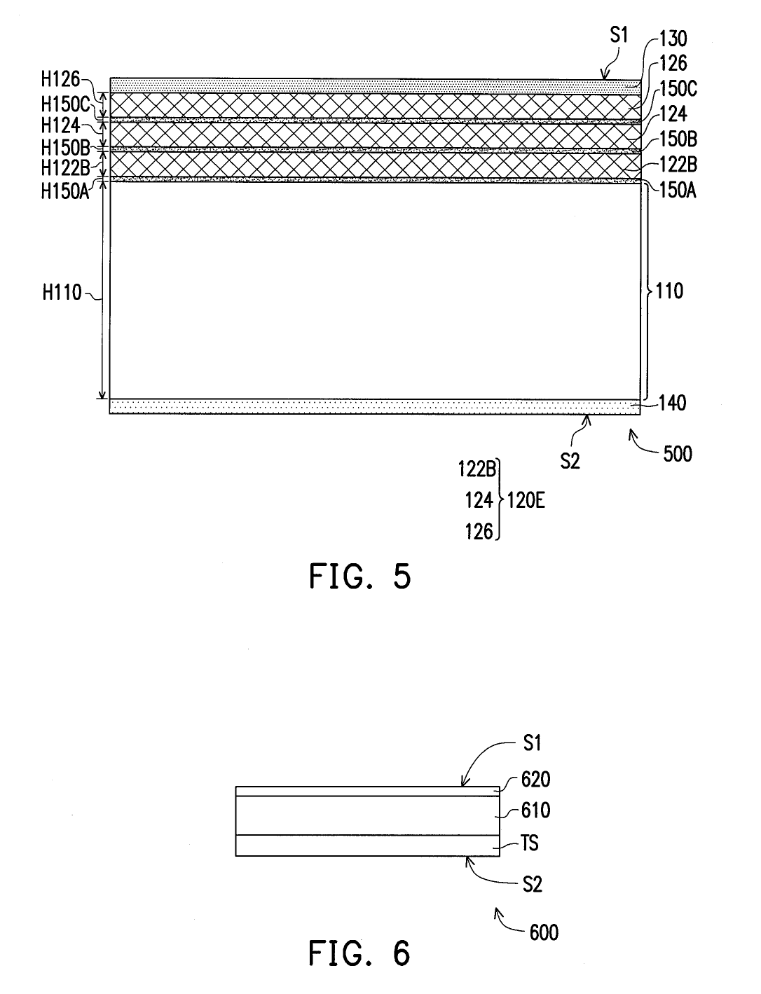

FIG. 5 is a cross-section schematic diagram of a composite touch cover plate according to the fifth embodiment of the invention. Please refer to FIG. 5, the touch cover plate 500 of the present embodiment has the similar structure and function to those of the touch cover plate 400 in FIG. 4. The difference between the touch cover plate 500 and the touch cover plate 400 is that fibrous layer 120E comprises a plurality of the sub-layers, and at least one of these sub-layers adheres to the polymer layer 110 through the bonding layer 150A. Further, the fiber layer 120E of the present embodiment includes the first sub-layer 122B, the second sub-layer 124, and the third sub-layer 126, wherein the method of forming the first sub-layer 122B, the second sub-layer 124, and the third sub-layer 126 can be used with the method of forming the fibrous layer 120C in FIG. 3. Specifically, the first sub-layer 122B adheres to the polymer layer 110 through the bonding layer 150A, the second sub-layer 124 adheres to the first sub-layer 122B through the bonding layer 150B, and the third sub-layer 126 adheres to the second sub-layer 124 through the bonding layer 150C.

In the present embodiment, the composite touch cover plate 500 is composed of the fibrous layer 120E having relatively high impact resistance capability and the polymer layer 110 having relatively high impact absorbing capability. Therefore, as the composite touch cover plate 500 is performed with a drop ball test or is under the impact of external forces, the fibrous layer 120E which is located at the touch surface S1 can resist the impact of external forces, thereby preventing the impacted touch surface S1 from directly rupturing. Also, as stresses pass down, the polymer layer 110 which is located below the fibrous layer 120E can absorb the stresses, thereby preventing the composite touch cover plate 500 from inside or bottom cracking. Accordingly, the composite touch cover plate 500 can have good tolerance under the impact of external forces.

It should be noted that, the invention is not intended to limit the number of the sub-layers of the fibrous layer 120E, but to illustrate the ratio of the total thickness of the fibrous layer 120E and the bonding layer (that is, the sum of the thickness H122B of the first sub-layer 122B, the thickness H124 of the second sub-layer 124, the thickness H126 of the second sub-layer 126, the thickness H150A of the bonding layer 150A, the thickness H150B of the bonding layer 150B, and the thickness H150C of the bonding layer 150C) to the thickness H110 of the polymer layer 110 lies between 1:9 and 1:49, and preferably lies between 1:9 and 1:19. In other embodiments, the number of the sub-layers can be determined based on requirement, and the number of the bonding layers can be the same as the number of the sub-layers.

The above composite touch cover plate 100, 200, 300, 400, 500 can be applied to a touch panel, a display panel and a touch display panel as a cover plate that carry devices. For example, in the display panel, the above composite touch cover plate 100, 200, 300, 400, 500 can be served as a substrate carrying a color filter device and/or an active device array, making the display panel having both the flexibility and the tolerance to the impact of external forces simultaneously. As to how to apply the above composite touch cover plate 100, 200, 300, 400, 500 to the touch panels will be illustrated by FIG. 6 as an example in the following.

FIG. 6 is a cross-section schematic diagram of a composite touch cover plate according to the sixth embodiment of the invention. Please refer to FIG. 6, the composite touch cover plate 600 of the present embodiment includes a polymer layer 610, a fibrous layer 620, and a touch sensor layer TS, wherein the polymer layer 610 and the fibrous layer 620 can be used with the structures, materials, and the forming methods of the above composite touch cover plate 100, 200, 300, 400, 500.

The touch sensor layer TS is disposed on the inner surface S2 of the composite touch cover plate 600, and the polymer layer 610 is located between the touch sensor layer TS and the fibrous layer 620. Further, the touch surface S1 is at the side of the fibrous layer 620 in the composite touch cover plate 600, which is the touch side for the user, and also the impacted side in the drop ball test. As the composite touch cover plate 600 is performed with the drop ball test or is under the impact of external forces, the fibrous layer 620 which is located at the touch surface S1 encounters the impact of external forces in the first time. Since the fibrous layer 620 has a relatively high stiffness to resist the impact of external forces, the impacted touch surface is prevented from directly rupturing. Also, as stresses pass down, the polymer layer 610 which is located below the fibrous layer 620 can absorb the stresses, thereby preventing the composite touch cover plate 600 from inside or bottom cracking. Accordingly, the composite touch cover plate 600 can have good tolerance under the impact of external forces. In the present embodiment, the touch sensor layer TS may be either a transparent sensing electrode formed directly at a side of the inner surface S2 or a metal or a metal fine wire that are invisible to naked eyes. In other embodiments, the touch sensor layer TS may be a touch sensing substrate adhering to the side near the inner surface S2, wherein the touch sensing substrate is, for example, a transparent substrate with a single or double-sided transparent electrodes, metals, or metal fine wires. It should be noted that, in other embodiments, the touch sensing substrate may also be two transparent substrates both with transparent electrodes, metals, or metal fine wires. The transparent substrate may be glass, a plastic substrate, or a thin film.

In another embodiment, when the composite touch cover plate 600 and the display panel (not shown) are integrated into a touch display panel, the touch sensor layer TS is, for example, located between the polymer layer 610 and the display panel. Therefore, the fibrous layer 620 and the polymer layer 610 can protect the touch sensor layer TS and the display panel. Furthermore, by the characteristic of impact absorbing capability of the polymer layer 610, the display panel can be prevented from cracking due to stresses passing down when there is the impact of external forces. Accordingly, the display panel can have good tolerance.

In addition, a functional film can be further provided on the composite touch cover plate mentioned above, such as anti-glare film, anti-reflection film, or anti-smudge film. The functional film can be a single layer or multiple layers.

Based on the above, the composite touch cover plate of the invention is composed of the fibrous layer having relatively high impact resistance capability and the polymer layer having relatively high impact absorbing capability. Therefore, as the composite touch cover plate or the panel which is applied with composite touch cover plate are performed with drop ball tests or are under the impact of external forces, the fibrous layer which is located at the touch surface can resist the impact of external forces, thereby preventing the impacted touch surface from directly rupturing. Also, as stresses pass down, the polymer layer which is located below the fibrous layer can absorb the stresses, thereby preventing the composite touch cover plate or the panel which is applied with composite touch cover plate from inside or bottom cracking. Accordingly, the composite touch cover plate and the panel which is applied with composite touch cover plate can have good tolerance under the impact of external forces.

The invention has been disclosed above in the preferred embodiments, but is not limited to those. It is known to persons skilled in the art that some modifications and innovations may be made without departing from the spirit and scope of the invention. Therefore, the scope of the invention should be defined by the following claims.

What is claimed is:

1. A composite touch cover plate, having a touch surface and an inner surface opposite to the touch surface, the composite touch cover plate comprising:
a substantially homogeneous polymer layer; and
a fibrous layer, located at one side of the polymer layer and near the touch surface, and a ratio of a thickness of the fibrous layer to a thickness of the polymer layer lies between 1:9 and 1:49.

2. The composite touch cover plate as claimed in claim 1, wherein the ratio of the thickness of the fibrous layer to the thickness of the polymer layer lies between 1:9 and 1:19.

3. The composite touch cover plate as claimed in claim 1, wherein materials of the polymer layer comprise polycarbonate, polyethylene terephthalate, cellulose triacetate, polymethyl methacrylate, or polyimide.

4. The composite touch cover plate as claimed in claim 1, wherein materials of the fibrous layer comprise glass fiber, carbon fiber, plastic fiber, or a mixture of at least two of the above materials.

5. The composite touch cover plate as claimed in claim 4, wherein the materials of the fibrous layer further comprise a polymer base, and the glass fiber, the carbon fiber, the plastic fiber, or the mixture of at least two of the above materials are distributed in the polymer base.

6. The composite touch cover plate as claimed in claim 5, wherein materials of the polymer base are the same as materials of the polymer layer.

7. The composite touch cover plate as claimed in claim 5, wherein the fibrous layer adheres to the polymer layer through a bonding layer.

8. The composite touch cover plate as claimed in claim 4, wherein the materials of the fibrous layer further comprise a vitreous spacer, a plastic spacer, or a mixture of the above two materials to support between the glass fiber, the carbon fiber, the plastic fiber, or a mixture of at least two of the above materials.

9. The composite touch cover plate as claimed in claim 1, wherein an overall thickness of the composite touch cover plate lies between 0.3 mm and 2 mm.

10. The composite touch cover plate as claimed in claim 1, wherein an overall haze of the composite touch cover plate lies between 2% and 2.5%.

11. The composite touch cover plate as claimed in claim 1, wherein the fibrous layer comprises a plurality of sub-layers.

12. The composite touch cover plate as claimed in claim 11, wherein at least one of the sub-layer adheres to the polymer layer through a bonding layer, and a ratio of a total thickness of the fibrous layer and the bonding layer to the thickness of the polymer layer lies between 1:9 and 1:49.

13. The composite touch cover plate as claimed in claim 1, further comprising:
a first hardened layer, disposed above the fibrous layer; and
a second hardened layer, disposed below the polymer layer, and the fibrous layer and the polymer layer are located between the first and the second hardened layer.

14. The composite touch cover plate as claimed in claim 13, wherein a pencil hardness of the first hardened layer lies between 4H and 9H.

15. The composite touch cover plate as claimed in claim 14, wherein a pencil hardness of the second hardened layer is less then 1H.

16. The composite touch cover plate as claimed in claim 13, wherein thicknesses of the first hardened layer and the second hardened layer are respectively less then 10 μm.

17. The composite touch cover plate as claimed in claim 1, further comprising a touch sensor layer, wherein the polymer layer is located between the touch sensor layer and the fibrous layer.

18. The composite touch cover plate as claimed in claim 17, wherein the touch sensor layer comprises transparent electrodes, metals, or metal fine wires.

19. The composite touch cover plate as claimed in claim 1, wherein the polymer layer is softer than the fibrous layer.

20. The composite touch cover plate as claimed in claim 1, further comprising a functional film disposed thereon, wherein the functional film is an anti-glare film, an anti-reflection film, or an anti-smudge film.
